(19) United States
(12) Patent Application Publication
(10) Pub. No.: US 2025/0096226 A1
(43) Pub. Date: Mar. 20, 2025

(54) ROLL PRESS FOR TAILORED POROSITY ELECTRODES

(71) Applicant: GM GLOBAL TECHNOLOGY OPERATIONS LLC, DETROIT, MI (US)

(72) Inventors: Daniel Ryan, Fenton, MI (US); Xiaosong Huang, Novi, MI (US); Joel G. Toner, Imlay City, MI (US); Anil K. Sachdev, Rochester Hills, MI (US); Nicole Ellison, Southfield, MI (US)

(21) Appl. No.: 18/469,759

(22) Filed: Sep. 19, 2023

(51) Int. Cl. H01M 4/04; H01M 4/02

(52) U.S. Cl. CPC H01M 4/0435; H01M 4/0471; H01M 2004/021

(57) ABSTRACT

Aspects of the disclosure include a roll press design for manufacturing tailored porosity electrodes. An exemplary roll press includes a top roller and a bottom roller separated from the top roller by a gap. At least one of the top roller and the bottom roller includes a raised region and an indented region. The raised region includes a first radius and the indented region includes a second radius less than the first radius. The gap includes a distance selected to accommodate a current collector. The current collector includes a bare portion and a coated portion having thereon an electrode material of a first thickness. A difference between the first radius and the second radius is selected, based on the first thickness, to evenly distribute stress across the bare portion and the coated portion of the current collector during a calendering process for forming a tailored porosity electrode.

### INTRODUCTION

The present disclosure relates to battery cell manufacturing, and particularly to a roll press for manufacturing tailored porosity electrodes.

Electrodes are widely used in a range of devices that store electrical energy, including primary (non-rechargeable) battery cells, secondary (rechargeable) battery cells, fuel cells, and capacitors. An ideal electrode needs to balance various electrical energy storage characteristics, such as, for example, energy density, power density, maximum charging rate, internal leakage current, equivalent series resistance (ESR), charge-discharge cycle durability, high electrical conductivity, and low tortuosity. Electrodes often incorporate current collectors to supplement or otherwise improve upon these electrical energy storage characteristics. Current collectors can be added to provide a higher specific conductance and can increase the available contact area to minimize the interfacial contact resistance between the electrode and its terminal.

A current collector is typically a sheet of conductive material to which the active electrode material is attached. Aluminum foil, stainless steel, and titanium foil are commonly used as the current collector of an electrode. In some electrode fabrication processes, for example, a film that includes activated carbon powder (i.e., the active electrode material) is attached to a thin aluminum foil using an adhesive layer. To improve the quality of the interfacial bond between the film of active electrode material and the current collector, the combination of the film and the current collector is processed in a pressure laminator, for example, a calender. This process is generally known as calendering. Thus, the fabrication of an electrode typically involves the production of an active electrode material film and the lamination of that film onto a current collector.

### SUMMARY

In one exemplary embodiment a roll press is designed for manufacturing tailored porosity electrodes. The roll press includes a top roller and a bottom roller separated from the top roller by a gap. At least one of the top roller and the bottom roller includes a raised region and an indented region. The raised region includes a first radius and the indented region includes a second radius less than the first radius. The gap includes a distance selected to accommodate a current collector. The current collector includes a bare portion and a coated portion having thereon an electrode material of a first thickness. A difference between the first radius and the second radius is selected, based on the first thickness, to evenly distribute stress across the bare portion and the coated portion of the current collector during a calendering process for forming a tailored porosity electrode.

In addition to one or more of the features described herein, in some embodiments, an interface between the raised region and the indented region is tapered.

In some embodiments, the indented region is aligned to the coated portion of the current collector. In some embodiments, the raised region is aligned to the bare portion of the current collector.

In some embodiments, the roll press includes a heating element on the raised region. The heating element can be configured to conductively heat the bare portion of the current collector.

In some embodiments, the roll press includes a slip ring having an inner radius configured such that the slip ring can be slid over the raised region and an outer radius larger than the first radius.

In another exemplary embodiment a roll press is modified for manufacturing tailored porosity electrodes. The roll press includes a top roller, a bottom roller separated from the top roller by a gap, and a slip ring installed over at least one of the top roller and the bottom roller. The slip ring includes a first radius and the respective top roller or bottom roller onto which the slip ring is installed includes a second radius less than the first radius. The gap includes a distance selected to accommodate a current collector. The current collector includes a bare portion and a coated portion having thereon an electrode material of a first thickness. A difference between the first radius and the second radius is selected, based on the first thickness, to evenly distribute stress across the bare portion and the coated portion of the current collector during a calendering process for forming a tailored porosity electrode.

In some embodiments, the slip ring is aligned to the bare portion of the current collector.

In some embodiments, the roll press includes a heating element on the slip ring. The heating element can be configured to conductively heat the bare portion of the current collector.

In some embodiments, the first radius is an outer radius of the slip ring and an inner radius of the slip ring is larger than the second radius such that the slip ring can be slid over the respective top roller or bottom roller onto which the slip ring is installed.

In some embodiments, the roller includes a clamp that can be tightened to secure the slip ring to the respective top roller or bottom roller onto which the slip ring is installed. In some embodiments, the clamp includes at least one of a clasp, a pinch clamp, a buckle, and a strap.

In some embodiments, the slip ring includes a collar that wraps around an endwall of the respective top roller or bottom roller onto which the slip ring is installed.

In yet another exemplary embodiment a method can include providing a top roller, providing a bottom roller separated from the top roller by a gap, and installing a slip ring over at least one of the top roller and the bottom roller. The slip ring includes a first radius and the respective top roller or bottom roller onto which the slip ring is installed includes a second radius less than the first radius. The gap includes a distance selected to accommodate a current collector. The current collector includes a bare portion and a coated portion having thereon an electrode material of a first thickness. A difference between the first radius and the second radius is selected, based on the first thickness, to evenly distribute stress across the bare portion and the coated portion of the current collector during a calendering process for forming a tailored porosity electrode.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings.

FIG. 1 is a vehicle configured in accordance with one or more embodiments;

FIG. 2 is an example configuration of a roll press in accordance with one or more embodiments;

FIG. 3 is an example process for modifying a roll press in accordance with one or more embodiments;

FIG. 4 is an example configuration of a roll press in accordance with one or more embodiments;

FIG. 5A is an example roller having a negatively sloped profile in accordance with one or more embodiments;

FIG. 5B is an example roller having a flat profile in accordance with one or more embodiments;

FIG. 5C is an example roller having a positively sloped profile in accordance with one or more embodiments; and

FIG. 6 is a flowchart in accordance with one or more embodiments.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Electrodes often incorporate current collectors to supplement or otherwise improve upon the electrical energy storage characteristics of the final integrated device (e.g., a battery). A current collector typically includes a sheet of conductive material (e.g., aluminum foil) to which an active electrode material is attached. To improve the quality of the interfacial bond between the film of the active electrode material and the current collector, the combination of the film and the current collector is processed in a pressure laminator. Thus, the fabrication of an electrode typically involves the production of an active electrode material film and the lamination of that film onto a current collector (the so-called calendering process).

Calendering can be generally defined as the compression of a dried electrode (the latter typically resulting from the coating and drying of an electrode slurry) to reduce its porosity, improve particle contact, and enhance energy or power density. Conventional calendering processes have been used to improve various aspects of battery technology by offering, for example, a higher specific conductance, greater contact areas, and lower contact resistance in the electrode. There are several challenges, however, in optimizing the calendering process.

One such challenge, for example, is that the calendering of electrodes (e.g., cathodes) onto current collector substrates (e.g., foil substrates such as aluminum, stainless steel, and titanium) produces a wrinkling defect when targeting lower porosities. Wrinkling defects are found at the interface between the coated sections of the current collector (i.e., those portions having pressed electrode films) and the uncoated sections (i.e., bare sections of the current collector) and are caused due to the different material properties of the electrode and substrate materials. These defects worsen as the resultant porosity decreases, meaning that relatively lower porosity electrodes natively suffer from more pervasive wrinkling defects.

While there are several approaches to mitigating wrinkling defects, each comes at the cost of some tradeoff. For example, the naïve approach is to raise the porosity target, resulting in a proportional reduction in wrinkling defects at the cost of decreased electrode conductivity. Another approach is to fully cover the substrate, so that there is no interface at which wrinkle defects can occur. The trade off here is that bare foil sections are ideal for use as battery terminals, and simply removing the bare sections reduces battery efficiencies.

This disclosure introduces a new roll press design for manufacturing tailored porosity electrodes. Rather than raising porosity targets or removing (or reducing) the bare foil portions of an electrode, a roll press described herein is modified (or built de novo) to include raised and/or idented regions that evenly distribute calendering stress. These raised and/or indented regions can be designed to have a thickness that mimics the coating thickness, dependent on current collector strength properties, of the electrode film pressed onto the current collector substrate. In some embodiments, a coated current collector is passed though the modified roll press while ensuring that the interface (e.g., channels/edges) between the bare foil and coated portions of the substrate align with the raised and/or indented regions of the roll press. In this manner, the thickness delta between the coated and uncoated portions is greatly minimized (if not removed entirely), lowering wrinkling defects without sacrificing porosity targets and/or bare foil surface area. In some embodiments, the raised (or indented) regions of the roll press may have a sloping factor to more evenly distribute stress across the current collector for high loading applications, although this feature is not required.

A roll press constructed in accordance with one or more embodiments offers several technical advantages over prior designs. Notably, the modified roll press described herein can be used to manufacture electrodes without (or with greatly reduced) wrinkling defects. Batteries built from electrodes without wrinkles deliver a range of improved battery characteristics, as wrinkles can reduce electrode integrity (e.g., wrinkles can lead to poor adhesion between the coated electrode film and the current collector, resulting in regions of relatively weak attachment that is prone to delamination or peeling), increase electrical resistance (wrinkles can create gaps or areas of reduced contact between the electrode material and the current collector that can impede the flow of electrons), increase degradation and reduce cycle life (electrodes with wrinkles can experience increased stress and strain during charge-discharge cycles due to inconsistent mechanical properties, which can lead to accelerated degradation, cracking, or even electrode failure), increase thermal instabilities (wrinkles can trap electrolytes and inhibit heat dissipation, resulting in localized hotspots that can degrade the electrolyte), and reduce capacity and energy density (wrinkling defects can lead to uneven thickness distributions across the electrode surface and these non-uniformities can result in reduced active material utilization, lower capacity, and compromised energy density in the battery). Other advantages are possible. For example, while a roll press can be constructed de novo with raised and/or indented regions, aspects of the present disclosure (e.g., collar type slip rings and/or clips, discussed in greater detail below) can be leveraged to modify existing roll presses to reduce wrinkle defects without roller redesigns.

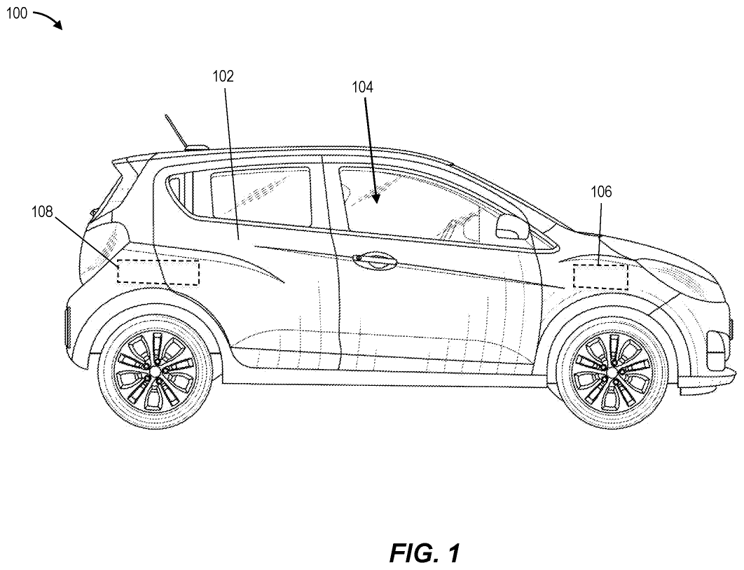

A vehicle, in accordance with an exemplary embodiment, is indicated generally at 100 in FIG. 1. Vehicle 100 is shown in the form of an automobile having a body 102. Body 102 includes a passenger compartment 104 within which are arranged a steering wheel, front seats, and rear passenger seats (not separately indicated). Within the body 102 are arranged a number of components, including, for example, an electric motor 106 (shown by projection under the front hood). The electric motor 106 is shown for ease of illustration and discussion only. It should be understood that the configuration, location, size, arrangement, etc., of the electric motor 106 is not meant to be particularly limited, and all such configurations (including multi-motor configurations) are within the contemplated scope of this disclosure.

The electric motor 106 is powered via a battery pack 108 (shown by projection near the rear of the vehicle 100). The battery pack 108 is shown for ease of illustration and discussion only. It should be understood that the configuration, location, size, arrangement, etc., of the battery pack 108 is not meant to be particularly limited, and all such configurations (including split configurations) are within the contemplated scope of this disclosure. Moreover, while the present disclosure is discussed primarily in the context of a battery pack 108 configured for the electric motor 106 of the vehicle 100, aspects described herein can be similarly incorporated within any system (vehicle, building, or otherwise) having an energy storage system(s) (e.g., one or more battery packs or modules), and all such configurations and applications are within the contemplated scope of this disclosure.

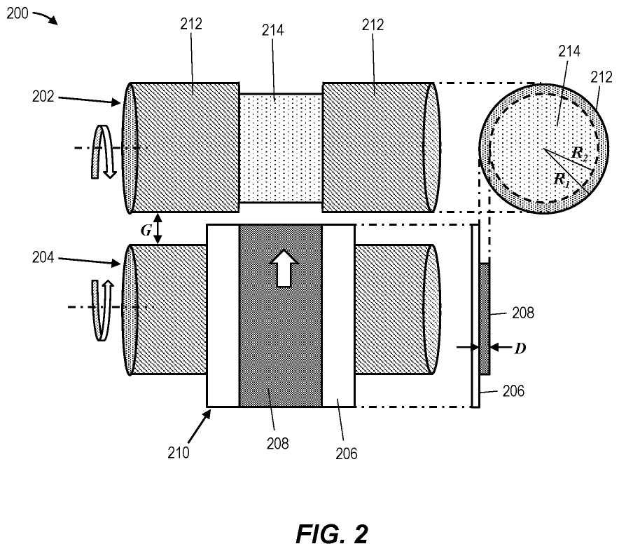

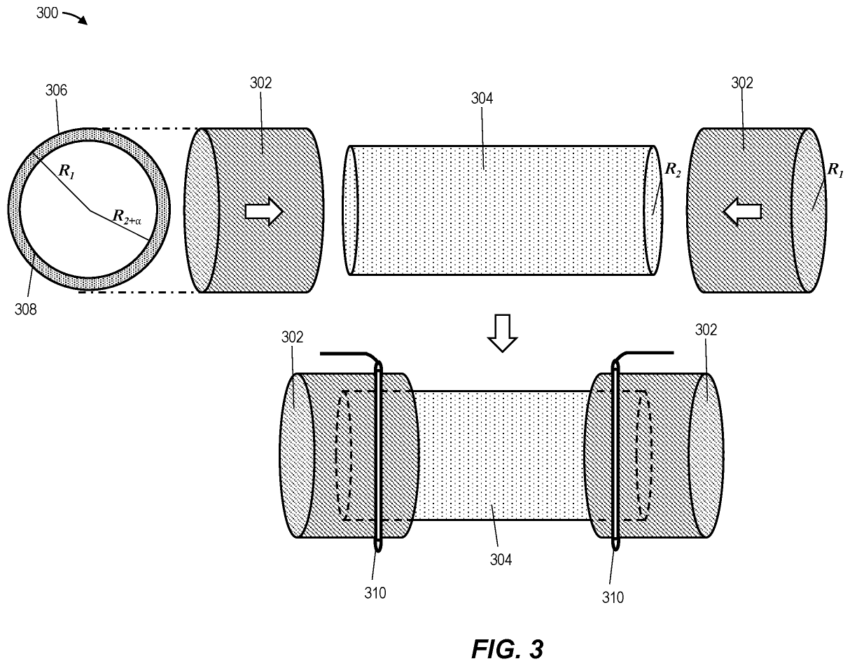

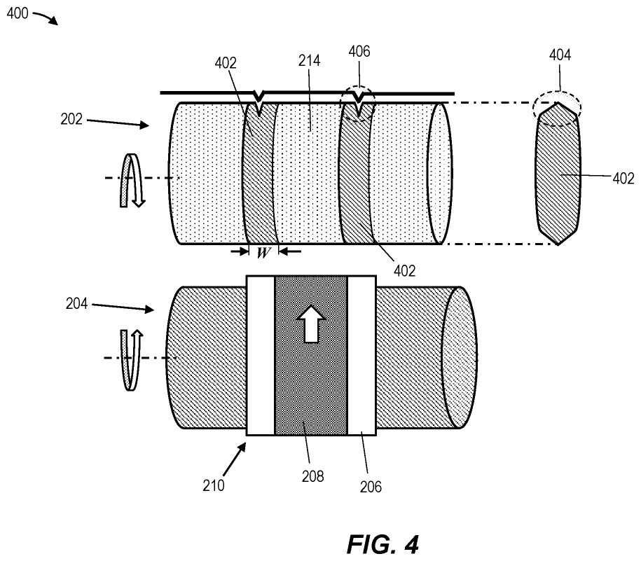

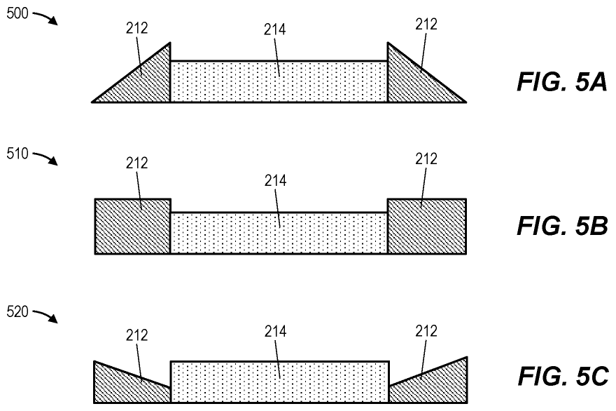

As will be detailed herein, the battery pack 108 includes one or more cells having low porosity electrodes (not separately shown) manufactured using a modified calendar roll press (refer to FIG. 2). In some embodiments, the roll press includes a collar-type modification, such as a ring, slide and/or clip that is fit over an existing roller (refer to FIG. 3). In some embodiments, the roll press is built de novo and can optionally include adjustable width and thickness options (refer to FIG. 4). In some embodiments, the shape/thickness and/or slope/taper of the raised region of the roll press is varied to distribute stress equally over bare foil and coated portions of a current collector (refer to FIGS. 5A, 5B, 5C).

FIG. 2 illustrates an example configuration of a roll press 200 in accordance with one or more embodiments. As shown in FIG. 2, the roll press 200 can include a top roller 202 and a bottom roller 204. In some embodiments, the top roller 202 and the bottom roller 204 can be positioned to apply pressure onto a current collector 206 coated with electrode material 208. This process, known as calendering, is designed to improve the density, uniformity, and overall performance of the resulting electrode 210 (i.e., the pressed current collector 206 and electrode material 208) by compressing and compacting the electrode material 208 onto a portion of the current collector 206.

The top roller 202 and the bottom roller 204 can be made of a durable material, such as steel, and can be manufactured with precision surfaces (e.g., sub 10 micron tolerances) to ensure uniform pressure distribution. In some embodiments, the top roller 202 is positioned vertically above the bottom roller 204 and a gap G can be adjusted by moving (e.g., hydraulically) one or both of the top roller 202 and the bottom roller 204 to control the amount of pressure applied.

In some embodiments, the manufacturing process for the electrode 210 is a continuous process whereby a source of the electrode material 208 is continuously applied to a surface of the current collector 206 prior to entering the gap G. In some embodiments, the current collector 206 is a sheet of conductive metal, such as aluminum foil, stainless steel, and titanium foil, to which the electrode material 208 is attached. Other materials are possible, such as, for example, semimetals (e.g., tin, graphite), and alloys of the metals and/or semimetals thereof. The electrode material 208 can include, for example, activated carbon powder, nickel manganese cobalt oxide (NMC), lithium iron phosphate (LFP), and nickel cobalt aluminum oxide (NCA).

In some embodiments, the roll press 200 includes several control parameters, such as, for example, a roll temperature (top and/or bottom), a calendering pressure, a gap distance, and a line speed. In some embodiments, the roll temperature is 50 degrees Celsius, the pressure is 4.5 Mpa, and the line speed is 0.5 meters per minute, although other process configurations are within the contemplated scope of this disclosure. The gap distance can be adjusted to the desired thickness of the electrode 210.

As the top roller 202 and/or the bottom roller 204 applies pressure, the coated current collector 206 with the electrode material 208 is compressed. The pressure applied by the top roller 202 and/or the bottom roller 204 compacts and compresses the electrode material 208. This helps improve the density of the electrode 210, removes voids and air pockets, and enhances the contact between the electrode material 208 and the current collector 206. The calendering process also results in a reduction in the thickness of the electrode material 208, as the electrode 210 is flattened under the pressure of the rollers.

In some embodiments, one of the top roller 202 and the bottom roller 204 are modified to include relatively raised regions 212 and/or relatively indented regions 214. In other words, the raised regions 212 can have a first radius R₁ and the indented regions 214 can have a second radius R₂ less than the first radius R₁. While the top roller 202 is shown having the raised regions 212 and indented regions 214, this is done for illustrative purposes only. Thickness and/or taper modifications can be made to either or both of the top roller 202 and the bottom roller 204 and all such configurations are within the contemplated scope of this disclosure.

In some embodiments, the interface (e.g., channels/edges) between the raised regions 212 and indented regions 214 are aligned to the current collector 206 and the electrode material 208 during the calendering process such that the current collector 206 contacts the raised regions 212 and the electrode material 208 contacts the indented regions 214.

In some embodiments, a thickness delta (i.e., R₁ less R₂) for a given application is selected to ensure an equal distribution of stress across the bare foil of the current collector 206 and the coated portions of the current collector 206 (those portions having electrode material 208) during the calendaring process. Observe that the thickness delta required to achieve a uniform stress distribution will vary based on the loading (e.g., milligrams per centimeter squared) and density of the electrode material 208, which together define a coating thickness D of the electrode material 208 above the bare portions of the current collector 206. In some embodiments, the thickness delta is proportional to (or equal to) the coating thickness D, depending on the strength properties of the current collector 206. In some embodiments, the interface between the raised regions 212 and the indented regions 214 can be sloped and/or tapered to more evenly distribute stresses, although sloping and/or tapering is not required (refer to FIGS. 5A, 5B, and 5C).

FIG. 3 illustrates an example process 300 for modifying a roll press in accordance with one or more embodiments. As shown in FIG. 3, a collar 302 having a first radius R₁ can be fit over opposite ends of a roller 304 having a second radius R₂. The roller 304 can be a top roller (e.g., the top roller 202) and/or a bottom roller (e.g., the bottom roller 204). The collar 302 can include, for example, a collar, a slide, and/or a ring manufactured to fit over the roller 304. In some embodiments, the collar 302 is hollow and includes an outer sidewall 306 having the first radius R₁ and an inner sidewall 308. In some embodiments, the inner sidewall 308 has a radius equal to, within tooling limits, the second radius R₂. In some embodiments, the inner sidewall 308 has a radius equal to the second radius R₂ plus a process margin a to ensure fit over the roller 304 (e.g,. R_{2+α}). While not meant to be particularly limited, the process margin a can range from 500 microns to several millimeters or more, for example 3 millimeters, depending on the required tolerances of a particular application.

As further shown in FIG. 3, in some embodiments, the collar 302 can include a clamp 310 to secure the collar 302 to the roller 304. In some embodiments, the clamp 310 is a clasp, pinch clamp, buckle, strap, etc., that can be fit over and/or integrated within the collar 302. In some embodiments, the clamp 310 is a pinch clamp designed to be positioned over the collar 302 after inserting the roller 304. The pinch clamp can then be tightened to secure the collar 302 to the roller 304. Advantageously, the clamp 310 can be loosened to release the collar 302, allowing for a new collar (not separately shown) to be fit over the roller 304. In this manner, any number of collars having outer sidewalls of various radiuses can be fixed to the roller 304 to accommodate a range of electrode designs (e.g., material selection and thickness targets, such as the coating thickness D of the electrode material 208 described previously).

FIG. 4 illustrates an example configuration of a roll press 400 in accordance with one or more embodiments. As shown in FIG. 4, the roll press 400 can include a top roller 202 and a bottom roller 204. In some embodiments, the top roller 202 and the bottom roller 204 can be positioned to apply pressure onto a current collector 206 coated with electrode material 208 during the manufacture of the electrode 210 as described previously. In contrast to the roll press 200 described with respect to FIG. 2, the roll press 400 includes slip rings 402. The slip rings 402 are shown applied to the top roller 202 for ease of illustration and discussion and can be applied to the top roller 202 and/or the bottom roller 204.

In some embodiments, the slip rings 402 are made of a material selected for thermal and mechanical stability during the calendering process. The slip rings 402 can include, for example, metal, hard plastic and/or polymer (e.g., polypropylene, HPDE), Teflon, neoprene, metal tape, etc., and combinations thereof. In some embodiments, the slip rings 402 are made of a material that is thermally stable to at least 150 degrees Celsius. In some embodiments, the slip rings 402 are made of a material that is mechanically stable at pressures of at least 4.5 Mpa. In some embodiments, the slip rings 402 are made of a material having minimal surface roughness. As used herein, a “minimal” surface roughness means a roughness average (RA) of less than 100, 50, 10, 5, 3, 2, 1, 0.5 microns, for example 20 microns. In some embodiments, the slip rings 402 are made of a material having a stiffness that matches a stiffness of the electrode material 208. Advantageously, a slip ring 402 made of a relatively stiff material can help prevent bending of the respective roller.

Slip rings 402 of various dimensions can be positioned over the respective roller (e.g., the top roller 202 and/or the bottom roller 204) to achieve relatively raised regions of any specification. In some embodiments, the slip rings 402 can be secured to the respective roller using clasps, pinch clamps, buckles, straps, etc., as described previously with respect to FIG. 3. In some embodiments, the slip rings 402 are made of a width W sufficient to fully overlap the bare portions of the current collector 206. For example, the width W can be the same (or larger to any desired tolerance and/or margin) as the corresponding width of the bare portion of the current collector 206. Notably, the slip rings 402 need not (but can) extend all the way to the end of the respective roller to ensure that calendering pressures are smoothly distributed.

In some embodiments, the slip rings 402 are made having a tapered and/or sloped profile 404. In some embodiments, the degree of tapering can be adjusted by swapping slip rings and/or by adjusting a slip ring having an adjustable taper. In some embodiments, slip rings 402 can be selected having a taper/sloped profile selected to more equally distribute stresses on the current collector 206 and/or the electrode material 208, for example, for higher loading applications.

In some embodiments, the slip rings 402 can be configured for local heating of the respective roller onto which it is installed. In some embodiments, the slip rings 402 include a heating element 406, such as a wire, embedded and/or installed onto the slip rings 402. In some embodiments, the heating element 406 can heat the respective covered portions of the roller to further soothe the bare foil portions of the current collector 206, further mitigating wrinkles caused during the calendering process. In some embodiments, the heating element 406 can heat the respective covered portions of the roller to temperatures of 400 degrees Celsius or more, although the specific temperature is not meant to be particularly limited.

FIGS. 5A, 5B, and 5C illustrate example tapering configurations in accordance with one or more embodiments. More specifically, FIG. 5A depicts an example roller 500 (e.g., the top roller 202 and/or the bottom roller 204) having a negatively sloped profile, FIG. 5B depicts an example roller 510 (e.g., the top roller 202 and/or the bottom roller 204) having a flat profile (i.e., no taper), and FIG. 5C depicts an example roller 520 (e.g., the top roller 202 and/or the bottom roller 204) having a positively sloped profile, each configured in accordance with one or more embodiments. The degree of slope (if any) shown in FIGS. 5A, 5B, and 5C is illustrative only and is not meant to be particularly limited. Other tapering profiles are possible, including linear and nonlinear profiles, and all such configurations are within the contemplated scope of this disclosure. For example, the rollers described herein can have spherical, curved, sharp, square, triangular, and/or patterned edge profiled as desired.

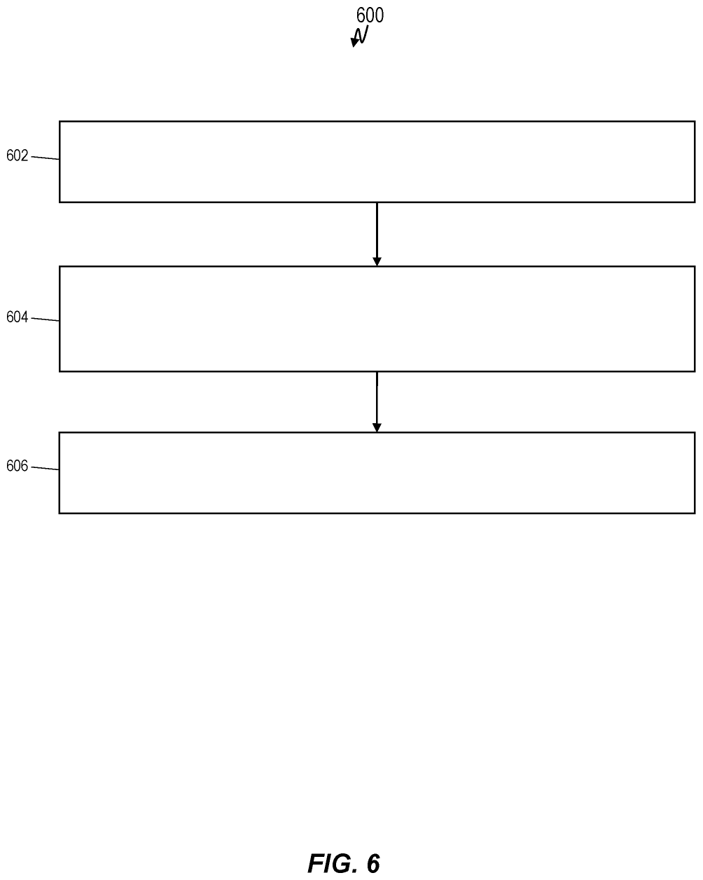

Referring now to FIG. 6, a flowchart 600 for modifying a roll press for manufacturing tailored porosity electrodes is generally shown according to an embodiment. The flowchart 600 is described in reference to FIGS. 1-5C and may include additional steps not depicted in FIG. 6. Although depicted in a particular order, the blocks depicted in FIG. 6 can be rearranged, subdivided, and/or combined.

At block 602, the method includes providing a top roller.

At block 604, the method includes providing a bottom roller separated from the top roller by a gap.

At block 606, the method includes installing a slip ring over at least one of the top roller and the bottom roller to adjust a thickness of a portion of the respective roller.

In some embodiments, the slip ring includes a first radius and the respective top roller or bottom roller onto which the slip ring is installed includes a second radius less than the first radius.

In some embodiments, the gap includes a distance selected to accommodate a current collector. In some embodiments, the current collector includes a bare portion and a coated portion having thereon an electrode material of a first thickness.

In some embodiments, a difference between the first radius and the second radius is selected, based on the first thickness, to evenly distribute stress across the bare portion and the coated portion of the current collector during a calendering process for forming a tailored porosity electrode.

In some embodiments, the slip ring is aligned to the bare portion of the current collector.

In some embodiments, the method includes providing a heating element on the slip ring. In some embodiments, the heating element is configured to conductively heat the bare portion of the current collector.

In some embodiments, the first radius is an outer radius of the slip ring and an inner radius of the slip ring is larger than the second radius such that the slip ring can be slid over the respective top roller or bottom roller onto which the slip ring is installed.

In some embodiments, the method includes providing a clamp that can be tightened to secure the slip ring to the respective top roller or bottom roller onto which the slip ring is installed. In some embodiments, the clamp includes at least one of a clasp, a pinch clamp, a buckle, and a strap.

In some embodiments, the slip ring includes a collar that wraps around an endwall of the respective top roller or bottom roller onto which the slip ring is installed.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A roll press for manufacturing tailored porosity electrodes, the roll press comprising:
a top roller; and
a bottom roller separated from the top roller by a gap;
wherein at least one of the top roller and the bottom roller comprises a raised region and an indented region, the raised region comprising a first radius and the indented region comprising a second radius less than the first radius;
wherein the gap comprises a distance selected to accommodate a current collector, the current collector comprising a bare portion and a coated portion having thereon an electrode material of a first thickness; and
wherein a difference between the first radius and the second radius is selected, based on the first thickness, to evenly distribute stress across the bare portion and the coated portion of the current collector during a calendering process for forming a tailored porosity electrode.

2. The roll press of claim 1, wherein an interface between the raised region and the indented region is tapered.

3. The roll press of claim 1, wherein the indented region is aligned to the coated portion of the current collector.

4. The roll press of claim 1, wherein the raised region is aligned to the bare portion of the current collector.

5. The roll press of claim 1, further comprising a heating element on the raised region, the heating element configured to conductively heat the bare portion of the current collector.

6. The roll press of claim 1, further comprising a slip ring having an inner radius configured such that the slip ring can be slid over the raised region, the slip ring having an outer radius larger than the first radius.

7. A roll press for manufacturing tailored porosity electrodes, the roll press comprising:
a top roller;
a bottom roller separated from the top roller by a gap; and
a slip ring installed over at least one of the top roller and the bottom roller;
wherein the slip ring comprises a first radius and the respective top roller or bottom roller onto which the slip ring is installed comprises a second radius less than the first radius;
wherein the gap comprises a distance selected to accommodate a current collector, the current collector comprising a bare portion and a coated portion having thereon an electrode material of a first thickness; and
wherein a difference between the first radius and the second radius is selected, based on the first thickness, to evenly distribute stress across the bare portion and the coated portion of the current collector during a calendering process for forming a tailored porosity electrode.

8. The roll press of claim 7, wherein the slip ring is aligned to the bare portion of the current collector.

9. The roll press of claim 7, further comprising a heating element on the slip ring, the heating element configured to conductively heat the bare portion of the current collector.

10. The roll press of claim 7, wherein the first radius is an outer radius of the slip ring and an inner radius of the slip ring is larger than the second radius such that the slip ring can be slid over the respective top roller or bottom roller onto which the slip ring is installed.

11. The roll press of claim 7, further comprising a clamp that can be tightened to secure the slip ring to the respective top roller or bottom roller onto which the slip ring is installed.

12. The roll press of claim 11, wherein the clamp comprises at least one of a clasp, a pinch clamp, a buckle, and a strap.

13. The roll press of claim 11, wherein the slip ring comprises a collar that wraps around an endwall of the respective top roller or bottom roller onto which the slip ring is installed.

14. A method comprising:
providing a top roller;
providing a bottom roller separated from the top roller by a gap; and
installing a slip ring over at least one of the top roller and the bottom roller to adjust a thickness of a portion of the respective roller;
wherein the slip ring comprises a first radius and the respective top roller or bottom roller onto which the slip ring is installed comprises a second radius less than the first radius;
wherein the gap comprises a distance selected to accommodate a current collector, the current collector comprising a bare portion and a coated portion having thereon an electrode material of a first thickness; and
wherein a difference between the first radius and the second radius is selected, based on the first thickness, to evenly distribute stress across the bare portion and the coated portion of the current collector during a calendering process for forming a tailored porosity electrode.

15. The method of claim 14, wherein the slip ring is aligned to the bare portion of the current collector.

16. The method of claim 14, further comprising providing a heating element on the slip ring, the heating element configured to conductively heat the bare portion of the current collector.

17. The method of claim 14, wherein the first radius is an outer radius of the slip ring and an inner radius of the slip ring is larger than the second radius such that the slip ring can be slid over the respective top roller or bottom roller onto which the slip ring is installed.

18. The method of claim 14, further comprising providing a clamp that can be tightened to secure the slip ring to the respective top roller or bottom roller onto which the slip ring is installed.

19. The method of claim 18, wherein the clamp comprises at least one of a clasp, a pinch clamp, a buckle, and a strap.

20. The method of claim 14, wherein the slip ring comprises a collar that wraps around an endwall of the respective top roller or bottom roller onto which the slip ring is installed.
